(19) United States
(12) Patent Application Publication
(10) Pub. No.: US 2015/0066967 A1
(43) Pub. Date: Mar. 5, 2015

(54) DETERMINING SEARCH QUERY HINTS USING CONTENT KEYWORDS

(71) Applicants: William David Reardon, Santa Monica, CA (US); Kai Chen, Santa Monica, CA (US)

(72) Inventors: William David Reardon, Santa Monica, CA (US); Kai Chen, Santa Monica, CA (US)

(73) Assignee: Google Inc.

(21) Appl. No.: 13/449,668

(22) Filed: Apr. 18, 2012

(51) Int. Cl. G06F 17/30

(52) U.S. Cl. 707/758; 707/E17.014

(57) ABSTRACT

A method for selecting content and search terms for display on a webpage includes receiving a request to provide content on a blank webpage and selecting, using an electronic device, content for display on the webpage. The content is selected based on one or more keywords associated with the webpage. The method further includes logging selections of content by users accessing the webpage and analyzing performance of the content using the electronic device by studying the logged selections. The content is associated with one or more keywords. The method further includes selecting selectable search terms related to the one or more keywords associated with the best-performing content, and displaying the selectable search terms on the webpage.

### BACKGROUND

The present disclosure relates generally to providing content on a webpage. More specifically, the present disclosure relates to providing content such as advertisements and search terms on a webpage.

On an undeveloped website domain (or on another webpage of the website that does not have content), it may be desired to display content instead of a blank page. The blank page may be a webpage such as a 404 error page, an undeveloped webpage (e.g., a webpage created by a publisher but for which the publisher does not yet have content for display), a non-existing webpage (e.g., a webpage reached by mistyping a URL), or any other type of webpage for which the publisher does not have content to display on. One way to provide content to display on the blank page is to display advertisements. The advertisements may be related to the domain.

### SUMMARY

One implementation of the present disclosure relates to a method for selecting content and search terms for display on a webpage. The method includes receiving a request to provide content on the webpage and selecting content for display on the webpage. The content may be selected based on one or more keywords associated with the webpage. The method further includes logging selections of content by users accessing the webpage and analyzing performance of the content. The content may be associated with one or more keywords. The method further includes selecting selectable search terms related to the keywords associated with the best-performing content and displaying the selectable search terms on the webpage.

Another implementation of the present disclosure relates to a computer readable storage medium having instructions stored therein, the instructions being executable by one or more processors to cause the one or more processors to perform operations. The operations include receiving a request to provide content on the webpage and selecting, content for display on the webpage. The content may be selected based on one or more keywords associated with the webpage. The operations further include logging selections of content by users accessing the webpage and analyzing performance of the content. The content may be associated with one or more keywords. The operations further include selecting selectable search terms related to the keywords associated with the best-performing content and displaying the selectable search terms on the webpage.

Another implementation of the present disclosure relates to a system for selecting content and search terms for display on a webpage. The system includes a processing circuit operable to receive a request to provide content on the webpage and select content for display on the webpage. The content may be selected based on one or more keywords associated with the webpage. The processing circuit is further operable to log selections of content by users accessing the webpage and analyze performance of the content. The content may be associated with one or more keywords. The processing circuit is further operable to select selectable search terms related to the keywords associated with the best-performing content and display the selectable search terms on the webpage.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a computer system in accordance with a described implementation.

FIG. 2 is a more detailed block diagram of the content management system of the computer system of FIG. 1 in accordance with a described implementation.

FIG. 3 illustrates an example website including content in accordance with a described implementation.

FIG. 4 is a flow chart of a process for selecting content and search terms for display on a webpage in accordance with a described implementation.

### DETAILED DESCRIPTION OF THE EXEMPLARY IMPLEMENTATIONS

Referring generally to the figures, systems and methods for determining search query hints using content keywords are shown. The search query hints are used by a publisher of a website to provide content that may be of interest to users of the website.

On an undeveloped website domain (or on another webpage of the website that does not have content), a publisher may provide content for display instead of providing a blank page, a “404 not found” message, an error message, etc. The content may be advertisements, according to one implementation. The types of advertisements may vary. For example, the advertisements may be text or image advertisements that a user can select. The content provided for display may also include selectable search terms. When a user selects a selectable search term displayed on the website, advertisements related to the selectable search terms may be displayed. The advertisements, selectable search terms, and other types of content may be related to the domain and/or domain name of the website.

When content is selected on the website, the selection may be logged along with the performance of the content. For example, if the content was an advertisement, if the click through rate (CTR) or other metric related to user selection of the advertisement is tracked, the corresponding performance may relate user purchases a product or service the advertisement promoted (or other revenue information related to the advertisement), etc. The keywords or other selection criteria associated with the best-performing content may be determined. The keywords may often include terms that represent a semantic and commercial explanation of the product or service in the advertisement or of the domain of the website. A keyword may be considered more relevant to the website and domain if the content associated with the keyword performs well.

The best-performing keywords (e.g., the keywords of the best-performing content) may be used as search query hints to assist in determining content to display on the website. These search query hints may assist in determining content by helping determine which selectable search terms to display on the website, which text advertisements to display, or determining other content for display on the website.

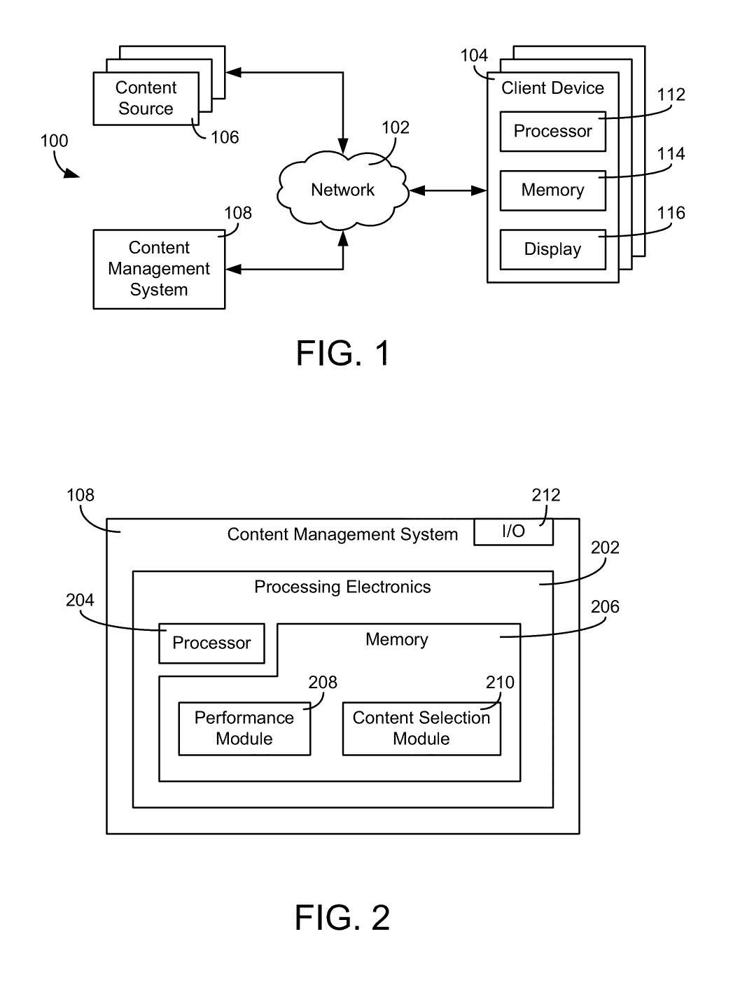

Referring to FIG. 1, a block diagram of a computer system 100 is accordance with a described implementation is shown. Computer system 100 includes one or more client devices 104 which communicate with other computing devices via a network 102. Client device 104 may execute a web browser or other application to retrieve content from other devices via network 102. For example, client device 104 may communicate with any number of content sources 106. Content sources 106 may provide webpage data and/or other content (e.g., text documents, PDF files, and other forms of electronic documents) to a client device 104. In some implementations, computer system 100 may also include a content management system 108 configured to manage content provided to client devices 104 by content sources 106 or another source connected to network 102. Content management system 108 is shown remotely connected to content sources 106 and client devices 104; in other implementations, content management system 110 may be local to content sources 106 or client devices 104. In general, computer system 100 is shown as an illustrative system that selects content for display on client devices 104 using selection features of the content.

Network 102 may be any form of computer network that relays information between content sources 106 and client devices 104. For example, network 102 may include the Internet and/or other types of data networks, such as a local area network (LAN), a wide area network (WAN), a cellular network, satellite network, or other types of data networks. Network 102 may also include any number of computing devices (e.g., computers, servers, routers, network switches, etc.) that are configured to receive and/or transmit data within network 102. Network 102 may further include any number of hardwired and/or wireless connections. For example, client device 104 may communicate wirelessly (e.g., via WiFi, cellular, radio, etc.) with a transceiver that is hardwired (e.g., via a fiber optic cable, a CAT5 cable, etc.) to other computing devices connected to network 102.

Client device 104 may be any number of different types of user electronic devices configured to communicate via network 106 (e.g., a laptop computer, a desktop computer, a mobile phone or other mobile device, a tablet computer, a smartphone, a digital video recorder, a set-top box for a television, a video game console, combinations thereof, etc.). Client device 104 is shown to include a processor 112 and memory 114, i.e., a processing circuit. Memory 114 may store machine instructions that, when executed by processor 112 to cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python, and Visual Basic.

Client device 104 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client device 104 (e.g., a built-in display, microphone, etc.) or external to the housing of client device 104 (e.g., a monitor or speaker connected to client device 104, etc.), according to various implementations. For example, client device 104 may include an electronic display 116, which displays webpages and other data received from content sources 106 and/or content management system 108.

Content sources 106 may be one or more electronic devices connected to network 102 that provide content to client devices 104. For example, content sources 106 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, and other forms of electronics documents.

According to various implementations, content sources 106 may provide webpage data to client devices 104 that includes one or more content tags. In general, a content tag may be any piece of webpage code associated with including content with a webpage. According to various implementations, a content tag may define a slot on a webpage for additional content, a slot for out of page content (e.g., an interstitial slot), whether content should be loaded asynchronously or synchronously, whether the loading of content should be disabled on the webpage, whether content that loaded unsuccessfully should be refreshed, the network location of a content source that provides the content (e.g., content sources 106, content management system 108, etc.), a network location (e.g., a URL) associated with clicking on the content, how the content is to be rendered on a display, one or more keywords used to retrieve the content, and other functions associated with providing additional content with a webpage. For example, content sources 106 may provide webpage data that causes client devices 104 to retrieve an advertisement from content management system 108. In another implementation, the advertisement may be selected by content management system 108 and provided by a content source 106 as part of the webpage data sent to client device 104.

Similar to content sources 106, content management system 108 may be one or more electronic devices connected to network 102 that provide advertisements and/or other content to client devices 104. Content management system 108 may be a computer server (e.g., FTP servers, file sharing servers, web servers, etc.) or a combination of servers (e.g., a data center, a cloud computing platform, etc.). Content management system 108 may include a processing circuit including a processor and memory as described above. The processing circuit of content management system 108 may be configured to select content to provide to a client device 104 or to provide content sources 106 with information allowing the content sources 106 to select content to provide to a client device 104. For example, content management system 108 may select content, such as an advertisement, to be provided with a webpage served by content sources 106.

Content selected by content management system 100 may be provided to a client device 104 by content sources 106 or content management system 108. For example, content management system 108 may select content from content sources 106 to be included with a webpage served by a content source 106. In another example, content management system 108 may provide the selected content to a client device 104. In some implementations, content management system 108 may select content stored in memory 114 of a client device 104. The content may be selected based on content keywords, in accordance with one implementation. For example, content management system 108 may select content, such as an advertisement, if the content has one or more keywords that are a match with the website on client device 104. The content may include advertisements, selectable search terms, search query hints, etc.

The selection of content may further be based on one or more user identifiers associated with client device 104. The user identifiers may refer to any form of data that may be used to represent one or more users that have opted into or have not opted out of receiving relevant content selected by content management system 108. In some implementations, a user identifier may be associated with a client identifier that identifies a client device to content management system 108 or may itself be the client identifier. In some implementations, a user identifier may be associated with multiple client identifiers (e.g., a client identifier for a mobile device, a client identifier for a home computer, etc.). Client identifiers may include, but are not limited to, cookies, device serial numbers, user profile data, telephone numbers, or network addresses. For example, a client identifier associated with client device 104 may be used to identify client device 104 and the client to content management system 108. In another implementation, user identifiers and client identifiers may be anonymous. For example, a client identifier may include information about a user and client device, but not information that would identify the user to content management system 108. Content management system 108 may then use the client identifier and user identifiers for content selection (as described below) without knowledge of the identity of the user.

Content management system 108 may use information associated with a user identifier in addition to keyword information to select relevant content for the user identifier. For example, content management system 108 may analyze history data associated with a user identifier to determine one or more potential interest categories for the user identifier. History data may be any data associated with a user identifier that is indicative of an online action (e.g., visiting a webpage, selecting an advertisement, navigating to a webpage, making a purchase, downloading content, etc.). Advertisers and other content sources that have content matching an interest category of a user identifier may select content to be provided to a device associated with the user identifier. For example, content management system 108 may select content to be displayed with a certain webpage by client device 104. While the present disclosure describes systems and methods for content selection based on keywords and content performance, in various implementations, user identifiers may be used in addition to keywords and content performance to select content.

The content provided by content sources 106 may be advertisements. The advertisements may be image advertisements, flash advertisements, video advertisements, text-based advertisements, or any combination thereof. It should be understood that while the present disclosure describes the use of text advertisements and search terms, the type of advertisement or other content displayed via a client device 104 may vary according to various implementations.

Computer system 100 is illustrated as an example environment for use with the systems and methods of the present disclosure; in various implementations, computer system 100 may include more or less systems and modules for use with the systems and methods of the present disclosure.

Referring now to FIG. 2, a more detailed block diagram of content management system 108 is shown, according to an exemplary embodiment. Content management system 108 selects content to display on client devices 104. In one implementation, content management system 108 is configured to select content for a webpage displayed on client devices 104. The webpage may be an undeveloped domain, an empty page, an error page (e.g., a “page not found” error page), or any other type of webpage where the publisher of the webpage has no or an insufficient amount of content to display. Content management system 108 may select content to display on the webpage in lieu of leaving the webpage blank or with an error message.

Content management system 108 includes processing electronics 202 including a processor 204 and memory 206. Processor 204 may be implemented as a general purpose processor, an application specific integrated circuit (ASIC), one or more field programmable gate arrays (FPGAs), a group of processing components, or other suitable electronic processing components. Memory 206 is one or more devices (e.g., RAM, ROM, Flash memory, hard disk storage, etc.) for storing data and/or computer code for completing and/or facilitating the various processes described herein. Memory 206 may be or include non-transient volatile memory or non-volatile memory. Memory 206 may include data base components, object code components, script components, or any other type of information structure for supporting the various activities and information structures described herein. Memory 206 may be communicably connected to processor 204 and includes computer code or instructions for executing one or more processes described herein.

Content management system 108 includes an input/output (I/O) interface 212 that may be configured to receive data from various media channels and to transmit advertisements and advertisement information to the various media channels as described above. I/O interface 212 may be configured to facilitate communications, either via a wired connection or wirelessly, with the multiple media channels, network, advertisers, and other devices as described in the present disclosure.

Memory 206 includes various modules for completing the methods described herein. It should be understood that memory 206 may include more or less modules, and that some of the activity described as occurring within memory 206 and processing electronics 202 may be completed by modules located remotely from advertisement management system 200 or processing electronics 202.

Memory 206 is shown to include a performance module 208. Performance module 208 may generally be configured to evaluate performance of content displayed on a webpage of a client device 104. When a user selects content (e.g., an advertisement) on the webpage, the performance of the content may be evaluated. The performance may be calculated using various metrics. For example, if the content is an advertisement, a click through rate (CTR) may be calculated (e.g., the number of clicks on the advertisement compared to the number of times the advertisement is shown on the webpage). The advertisements may be ranked based on their CTR, according to one implementation. As another example, the number of clicks on the advertisement may be totaled. As yet another example, other metrics such as impressions or views (the number of times an advertisement is shown on a webpage), a cost per action or click (e.g., the number of actions or clicks a user makes after selecting an advertisement), or revenue may be used to evaluate content performance.

Memory 206 further includes a content selection module 210. Content selection module 210 may determine content to display on a webpage (e.g., a webpage displayed on client device 104). The content may be advertisements (e.g., image advertisements, video advertisements, text advertisements, search terms, etc.), according to one implementation. Content selection module 210 may determine which content to display on the webpage based on the type of webpage and on performance of content previously displayed on the webpage.

For example, content selection module 210 may initially select content (e.g., multiple advertisements) to display on the webpage. The advertisements may be selected based on webpage information. For example, if the website is a parked domain and the URL includes the word “car”, or if the webpage is an error page for a website about cars, the advertisement may be related to cars. For example, some of the advertisements that are selected may relate to sportscars, some of the advertisements may relate to foreign cars, some of the advertisements may be relate to car insurance, etc. In other words, advertisements may be related to the topic of the webpage but may vary from other advertisements shown on the webpage in other ways.

The performance of the advertisements may be evaluated by, for example, performance module 208. Using the performance evaluation, selection criteria (e.g., related search terms) are determined. Using the selection criteria, content selection module 210 selects content for display on the webpage again. For example, the URL, subject or topic of the domain may be related to bats, and one keyword of the domain may be “bat.” Ads may be displayed on the domain that relate to bats. A list may be generated of the keywords of ads that have been clicked on. For example, the list may include “baseball bat”, “cricket bat”, and other keywords that may have been used in connection with well-performing, bat-related advertisements. “Baseball bat,” “cricket bat” and the other keywords are then displayed as related search queries. The performance of each keyword may be tracked (e.g., it may be determined that “baseball bat” performs better than “cricket bat”). Then, when another user selects a search term, the best performing keywords (e.g., “baseball bat”) may be used to refine the type of advertisement displayed (e.g., more ads relating to baseball bats may be shown than ads related to cricket bats).

As another example, for a webpage associated with vehicles, if text advertisements related to sportscars (e.g., advertisements with the keyword “sportscars”, or advertisements that are about sportscars) are performing better than other car advertisements on the webpage, content selection module 210 may select search terms related to “sportscars” to display on the webpage as related search queries. The terms that are selected may be those terms that are the keywords for the advertisements that are performing well (in this example, the advertisements relating to sportscars).

In one implementation, content selection module 210 may assign weights to different keywords based on performance evaluation from performance module 208. For example, the keywords of the best-performing content may be assigned a greater weight than keywords of lesser-performing content. Content selection module 210 may then use the weights to determine when or how often to select a particular advertisement for display.

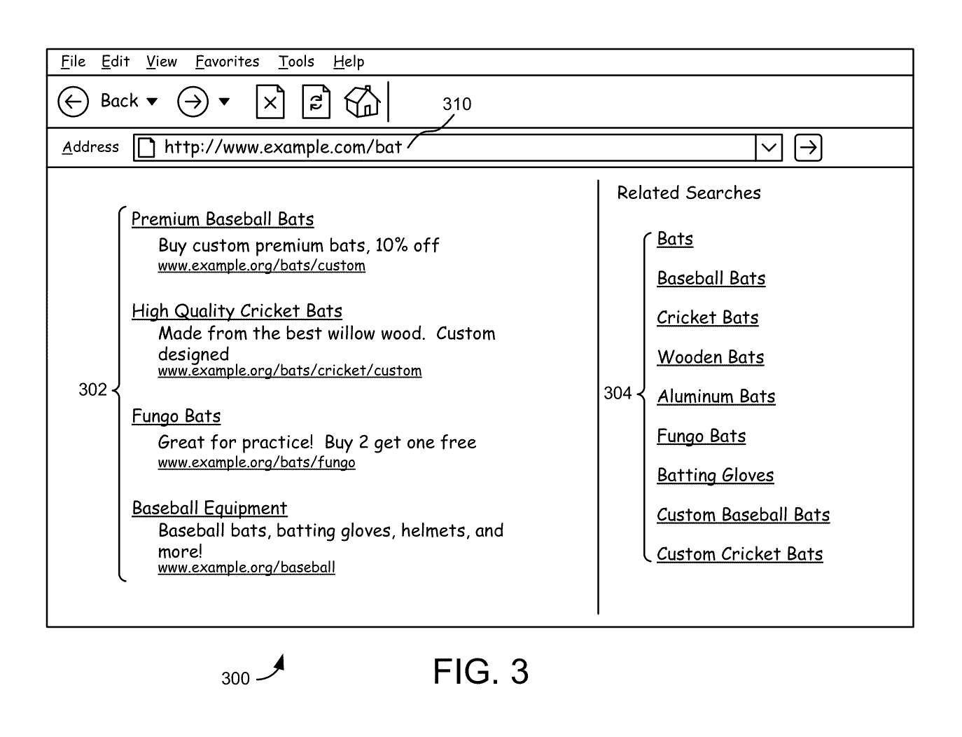

Referring to FIG. 3, an example webpage 300 for which content may be provided for display is shown, in accordance with a described implementation. For example, webpage 300 may be an undeveloped domain. As another example, webpage 300 may be an error page (e.g., the user may have typed in a wrong URL and the webpage is a page the user is redirected to) and content is provided for display on webpage 300 instead of or in addition to an error message. As yet another example, webpage 300 may be a webpage without content that is visited by a user via a search. Webpage 300 may receive content from a content management system 108 or another similar system for content selection, from a content source 106, or via another source via network 102.

Two types of content may be displayed on webpage 300. For example, text advertisements 302 and related search terms 304 may be displayed. Text advertisements 302 and related search terms 304 may be selected based on the webpage. In one implementation, advertisements 302 and search terms 304 are selected based on a topic of the webpage, keywords associated with the webpage, or other webpage data. For example, if a user navigated to the webpage from another link, the webpage on which the link was displayed may be used to determine a topic or keyword. As another example, if the webpage was reached because of a typographical error, content selection module 210 or another module may determine an intended user input and use the determination as a topic or keyword. As other examples, metadata of the webpage may be used to determine a topic, a publisher of a webpage may associate the webpage with a topic or keyword, etc. The determination of a topic, keyword, or other webpage property may be performed by a keyword or topic selection tool or other module of memory 206.

Text advertisements 302 may be advertisements selected by, for example, content selection module 210. Text advertisements 302 may relate to a topic or subject of webpage 300. For example, in the implementation of FIG. 3, the URL includes the term “bat”; therefore, text advertisements 302 may be advertisements related to bats. Text advertisements 302 may be related to different types of bats or may otherwise be related to bats in various ways. For example, one text advertisement is shown related to baseball bats, another text advertisement is shown related to cricket bats, another is shown related to equipment related to batting in baseball, etc. The relation of the advertisements to the topic or subject of webpage 300 may be based on the actual keywords associated with webpage 300 (e.g., “bat”) or may be based on any type of interpretation of the keywords.

Related search terms 304 are shown as another type of content that is selected for display on webpage 300. Related search terms 304 may be selectable by a user of webpage 300. Upon selection, the user may be presented with additional advertisements (e.g., image advertisements, text advertisements, or any other type of advertisement) or other search results related to related search terms 304 (e.g., advertisements with a keyword that matches or is similar to the related search terms). In FIG. 3, search terms related to “bat” are provided for display: “baseball bats”, “cricket bats”, “wooden bats”, “fungo bats,” etc. For example, an advertisement related to fungo bats may be associated with the keywords “bats” and “fungo bats.” The keyword “bats” may be the keyword that causes the fungo bats advertisement to be selected and displayed among text advertisements 302. When the advertisement for fungo bats performs well, another more detailed keyword associated with the same advertisement (in this case, the “fungo bats” keyword) may be used as a related search term 304. If advertisements for aluminum fungo bats then start performing well, then “aluminum fungo bats” may be used as a related search term 304.

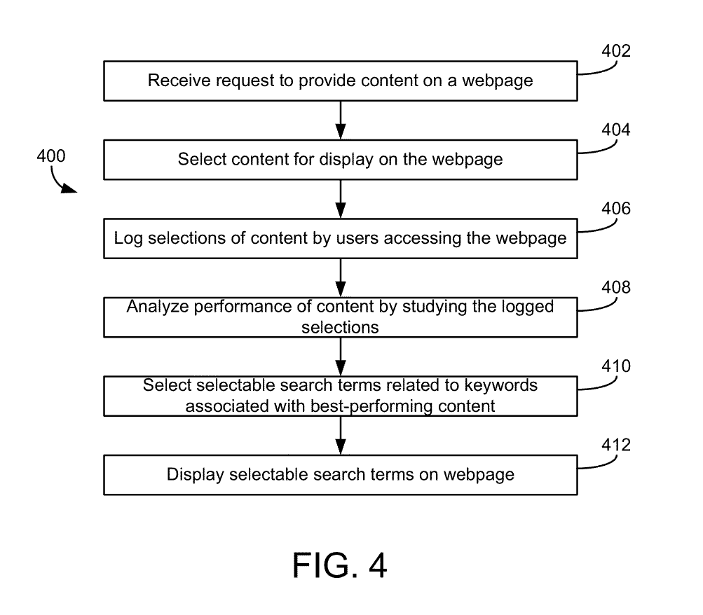

Referring now to FIG. 4, a flow chart of a process 400 for selecting content and search terms for display on a webpage is shown in accordance with a described implementation. Process 400 may be executed by, for example, a content management system 108 configured to select content for display on a webpage.

Process 400 may include receiving a request to provide content on a webpage (block 402) at, for example, a content management system 108. Process 400 may also include selecting content for display on a webpage (block 404). The selection of content may be made by, for example, a content management system 108. Referring also to FIG. 3, block 404 may include selecting text advertisements 302 and related search terms 304 for display on webpage 300.

Process 400 may further include logging selections of content by users accessing the webpage (block 406) and analyzing the performance of the content by studying the logged selections (block 408). For example, referring also to FIG. 3, block 406 may include determining when content is selected by a user and logging the selections, and block 408 may include analyzing the performance of the selected content based on one or more metrics (e.g., CTR). The selections may be logged in, for example, memory 206 of a content management system 108.

Process 400 may further include selecting selectable search terms related to keywords associated with the best -performing content (block 410). For example, referring also to FIG. 3, if text advertisement 302 relating to baseball bats is the best performing content, webpage 300 may be configured to show more related search terms 304 relating to baseball bats than other types of bats. The selectable search terms may then be displayed on the webpage (block 412).

Configurations of Various Exemplary Implementations

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices).

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a Web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for selecting content and search terms for display on a webpage, comprising:
receiving a request to provide content on a webpage corresponding to one of a parked domain or a webpage corresponding to an error page, the webpage configured to include a third-party content portion in which one or more third-party content items are provided for display and a search terms portion in which one or more search terms are provided for display;
identifying one or more web-page related keywords associated with the webpage;
selecting, using an electronic device, one or more third-party content items from a plurality of third-party content items for display on the webpage, wherein the third-party content items are selected based on the one or more identified webpage-related keywords associated with the webpage;
logging selections of the third-party content items selected for display by users accessing the webpage;
determining, by analyzing the logged selections using the electronic device, a best performing third-party content item from the third-party content items selected for display on the webpage, wherein the best performing third-party content item is associated with one or more content-related keywords, wherein at least one of the content-related keywords is different from the webpage related keywords;
identifying, for the best performing third-party content item, one or more content-related keywords associated with the best performing third-party content item different from the webpage-related keywords;
selecting one of the identified content-related keywords associated with the best performing third-party content item as a selectable search term;
identifying a previously selected search term that was previously provided for display, the previously selected search term selected by the electronic device in response to a second third-party content item of the plurality of one or more third-party content items previously determined as the best performing content, the previously selected search term selected based in part on being related to a content-related keyword associated with the second third-party content different from the webpage-related keywords; and
displaying the selectable search term on the webpage instead of the previously selected search term.

2. The method of claim 1, wherein the third-party content items comprise advertisements.

3. (canceled)

4. The method of claim 1, wherein the search terms are further selectable by the users of the webpage.

5. The method of claim 1, further comprising.
tracking performance of the selectable search terms; and
selecting additional selectable search terms based on the performance of the selectable search terms;
wherein the additional selectable search terms are related to the selectable search terms.

6. The method of claim 5, wherein the additional selectable search terms have a more specific meaning than the selectable search terms.

7. The method of claim 1, wherein determining the best performing third-party content item is based on one or more of a click through rate (CTR), total impressions, total views, total clicks, and revenue.

8. The method of claim 1, further comprising selecting a second set of content for display based on the selectable search terms, wherein the second set of content comprises website links related to the selectable search terms.

9. A tangible computer readable storage medium having instructions stored therein, the instructions being executable by one or more processors to cause the one or more processors to perform operations, comprising:
receiving a request to provide content on a webpage corresponding to one of a parked domain or a webpage corresponding to an error page, the webpage configured to include a third-party content portion in which one or more third-party content items are provided for display and a search terms portion in which one or more search terms are provided for display;
identifying one or more web-page related keywords associated with the webpage;
selecting, using an electronic device, one or more third-party content items for display on the webpage, wherein the third-party content items are selected based on the one or more identified webpage-related keywords associated with the webpage;
logging selections of the third-party content items selected for display by users accessing the webpage;
determining, by analyzing the logged selections using the electronic device, a best performing third-party content item from the third-party content items selected for display on the webpage, wherein the best performing third-party content item is associated with one or more content-related keywords, wherein at least one of the content-related keywords is different from the webpage related keywords;
identifying, for the best performing third-party content item, one or more content-related keywords associated with the best performing third-party content item different from the webpage-related keywords;
selecting one of the identified content-related keywords associated with the best performing third-party content item as a selectable search term;
identifying a previously selected search term that was previously provided for display, the previously selected search term selected in response to a second third-party content item of the one or more third-party content items previously determined as the best performing content, the previously selected search term selected based in part on being related to a content-related keyword associated with the second third-party content different from the webpage-related keywords; and
displaying the selectable search term on the webpage instead of the previously selected search term.

10. The tangible computer-readable storage medium of claim 9, wherein the third-party content items comprise advertisements.

11. (canceled)

12. The tangible computer-readable storage medium of claim 9, wherein the related search terms are further selectable by the users of the webpage.

13. The tangible computer-readable storage medium of claim 9, wherein operations further comprise:
tracking performance of the selectable search terms; and
selecting additional selectable search terms based on the performance of the selectable search terms;
wherein the additional selectable search terms are related to the selectable search terms.

14. The tangible computer-readable storage medium of claim 13, wherein the additional selectable search terms have a more specific meaning than the selectable search terms.

15. The tangible computer-readable storage medium of claim 9, wherein determining the best performing third-party content item is based on one or more of a click through rate (CTR), total impressions, total views, total clicks, and revenue.

16. The tangible computer-readable storage medium of claim 9, wherein the operations further comprise:
selecting a second set of content for display based on the selectable search terms, wherein the second set of content comprises website links selectable to the search terms.

17. A system for selecting content and search terms for display on a webpage, comprising a processing circuit operable to:
receive a request to provide content on a webpage corresponding to one of a parked domain or a webpage corresponding to an error page, the webpage configured to include a third-party content portion in which one or more third-party content items are provided for display and a search terms portion in which one or more search terms are provided for display;
select one or more third-party content items for display on the webpage, wherein the third-party content items are selected based on the one or more identified webpage-related keywords associated with the webpage;
log selections of the third-party content items selected for display by users accessing the webpage;
determine by analyzing the logged selections, a best performing third-party content item from the third-party content items selected for display on the webpage, wherein the best performing third-party content item is associated with one or more content-related keywords, wherein at least one of the content-related keywords is different from the webpage related keywords;
identify, for the best performing third-party content item, one or more content-related keywords associated with the best performing third-party content item different from the webpage-related keywords;
select one of the identified content-related keywords associated with the best performing third-party content item as a selectable search term;
identify a previously selected search term that was previously provided for display, the previously selected search term selected in response to a second third-party content item of the identified one or more third-party content items previously determined as the best performing content, the previously selected search term selected based in part on being related to a content-related keyword associated with the second third-party content different from the webpage-related keywords; and
display the selectable search term on the webpage instead of the previously selected search term.

18. The system of claim 17, wherein the third-party content items comprise advertisements.

19. (canceled)

20. The system of claim 17, wherein the search terms are further selectable by the users of the webpage.

21. A method for selecting content and search terms for display on a webpage, comprising:
receiving a request to provide content on a webpage corresponding to one of a parked domain or a webpage corresponding to an error page, the webpage configured to include a third-party content portion in which one or more third-party content items are provided for display and a search terms portion in which one or more search terms are provided for display;
identifying one or more web-page related keywords associated with the webpage;
selecting at a first instance, using an electronic device, one or more third-party content items from a plurality of third-party content items for display on the webpage, wherein the third-party content items are selected based on the one or more identified webpage-related keywords associated with the webpage;
logging selections of the third-party content items selected for display by users accessing the webpage;
determining, by analyzing the logged selections using the electronic device, a best performing third-party content item from the third-party content items selected for display on the webpage, wherein the best performing third-party content item is associated with one or more content-related keywords, wherein at least one of the content-related keywords is different from the webpage related keywords;
identifying, for the best performing third-party content item, one or more content-related keywords associated with the best performing third-party content item different from the webpage-related keywords;
selecting one of the identified content-related keywords associated with the best performing third-party content item as a selectable search term;
logging selections of selectable search terms including the selectable search term selected for display by users accessing the webpage;
determining, by analyzing the logged selections of the selectable search terms, a best performing selectable search term from the selectable search terms selected for display;
selecting at a second instance, using the electronic device, one or more replacement third-party content items based on the best performing selectable search term;
identifying a previously selected third-party content item that was previously provided for display; and
providing for display at least one of the replacement third-party content items on the webpage instead of the identified previously selected third-party content item.

22. The method of claim 1, wherein the content-related keywords include at least one keyword on which a content provider of the third-party content item has submitted a bid in a content serving auction.
